(19) United States
(12) Patent Application Publication
(10) Pub. No.: US 2025/0300452 A1
(43) Pub. Date: Sep. 25, 2025

(54) SURGE PROTECTION CIRCUIT

(71) Applicant: NexTek, LLC, North Billerica, MA (US)

(72) Inventor: Chris Penwell, Cheshire, CT (US)

(21) Appl. No.: 19/086,602

(22) Filed: Mar. 21, 2025

Related U.S. Application Data
(60) Provisional application No. 63/568,110, filed on Mar. 21, 2024.

(51) Int. Cl. H02H 9/04

(52) U.S. Cl. CPC H02H 9/04

(57) ABSTRACT

A surge protection circuit for transmitting electromagnetic signals within a desired frequency band includes a transmission line, a surge suppression device for treating any high-voltage, transient energy received by the transmission line, and a subcircuit for monitoring the operational state of the surge suppression device. Preferably, the surge suppression device is a three-electrode gas discharge tube (GDT) with one of its line electrodes connected to the transmission line and the other of its line electrodes connected to the monitoring subcircuit. The subcircuit comprises a monitoring port in communication with a thermal fuse which is mounted directly onto the casing of the GDT. When the GDT treats a transient impulse that results in its operational failure, the GDT casing rises to a threshold temperature which switches the state of the fuse. This causes the measured resistance at the monitoring port to change, thereby indicating that the GDT is operationally inactive.

### CROSS-REFERENCE TO RELATED APPLICATIONS

The present invention claims the benefit under 35 U.S.C. 119(e) to U.S. Provisional Patent Application No. 63/568,110, which was filed on Mar. 21, 2024, in the names of Chris Penwell et al.

### FIELD OF THE INVENTION

The present invention relates generally to electric devices for transmitting electromagnetic signals of a desired frequency range and, more particularly, to electric devices for transmitting electromagnetic signals of a desired frequency range that additionally provide over-voltage protection.

### BACKGROUND OF THE INVENTION

In electric communications, a transmission line, or signal path, is a structure designed to efficiently transmit electromagnetic signals, such as radio frequency (RF) signals, from a signal source to a load. The transmission line formed between the signal source and the load is commonly established using one or more electric devices, such as coaxial cables, connectors, and switches.

Electric devices of the type described above are widely used to transmit electromagnetic signals with minimum loss and limited distortion. As a result, these types of electric devices are commonly used to transmit and receive signals in telecommunications, broadcast, military, security, and civilian transceiver applications, as well as numerous additional uses.

An RF transmission line is often susceptible to receiving high-voltage transient electromagnetic energy, for instance, as the result of a lightning strike or electro-static discharge. This high-voltage energy is potentially harmful to not only a load in connection with the transmission line but also any voltage-sensitive circuit components present in an electric device which is used to define the signal path.

Accordingly, electric devices used to transmit electromagnetic energy are often provided with means for protecting the load from any potentially harmful, transient, high-voltage electromagnetic energy. In particular, electric devices with overvoltage protection, referred to herein simply as surge protection devices, are particularly needed for loads that include voltage sensitive circuitry that operates at a frequency range above approximately 10 MHZ, such as radio receivers, low-voltage control circuits and low-voltage communication circuits.

In FIG. 1, there is shown a schematic representation of a prior art surge protection circuit that is commonly incorporated into electric devices used to transmit electromagnetic signals within a certain frequency range of the radio frequency (RF) spectrum, the surge protection circuit being represented generally by reference numeral 11. As can be seen, surge protection circuit 11 comprises (i) a transmission line, or signal path, 13 that extends in electrical communication between an input port, or terminal, 15-1 and an output port, or terminal 15-2, (ii) a capacitor 17 connected in series on transmission line 13 between terminals 15-1 and 15-2 for filtering any electromagnetic energy on transmission line 13 that falls beneath the operational frequency band, and (iii) a surge protection device 19 that connects transmission line 13 to a ground terminal, or ground, 21, with surge protection device 19 being connected to transmission line 13 between input terminal 15-1 and capacitor 17.

In normal operation, circuit 11 is designed to pass RF signals of a designated frequency band between a signal source and a load. If any potentially harmful, transient, high-current RF energy is introduced to transmission line 13 (e.g., as a result of a lightning strike or electro-static discharge), protection device 19 turns on, or fires, and thereby suppresses the potentially harmful energy. As a result, any low-voltage circuitry connected to output terminal 15-2 is protected from the unwanted, high-voltage energy.

Surge protection device 19 is represented herein as a gas discharge tube (GDT). However, it is to be understood that alternative types of surge protection devices, such as shunting protectors and semi-conductor clamping components, are commonly utilized in place of or in combination with GDTs in surge protection circuits.

Referring now to FIGS. 2(a) and 2(b), there is shown one type of gas discharge tube that is commonly used in surge protection circuits, the GDT being identified generally by reference numeral 31. Gas discharge tube 31 is represented as a three-electrode, fail-short GDT of the type manufactured and sold by Bourns, Inc., of Riverside, California under its 2026-XX-C2F line of gas discharge tubes.

As can be seen, GDT 31 is a generally cylindrical member that includes a pair of disc-shaped, line electrodes, or terminals, 33-1 and 33-2 that are disposed on opposite sides of a central, disc-shaped, ground electrode, or terminal, 33-3 in a coaxial relationship relative thereto. Leads 35-1 thru 35-3 are shown conductively coupled to electrodes 33-1 thru 33-3, respectively, to facilitate mounting of GDT 31 onto a printed circuit board or other similar electrical structure.

Line electrodes 33-1 and 33-2 are maintained in a spaced apart, electrically insulated relationship relative to ground electrode 33-3 by a hollow, cylindrical, ceramic body, or casing, 37. The interior of body 37 is filled with a controlled gas that ordinarily acts as an insulator between electrodes 33. However, the introduction of high-voltage transient energy onto signal path 13 creates a voltage potential between electrodes 33 which, upon reaching a certain level, causes the internal gas to ionize. Ultimately, this ionization creates a low-resistance current path throughout the interior of GDT 31 that effectively discharges the high-current energy without increasing the arc voltage across terminals 33, thereby protecting the load from high-voltage energy.

Referring back to FIG. 1, surge protection circuit 11 is shown with line electrode 33-1 connected to transmission line 13 between input terminal 15-1 and capacitor 17. GDT 31 is designed such that line electrode 33-2 could be connected to transmission line 13 at another point along its length (i.e., to provide redundant surge protection) or to a separate circuit in need of surge protection. However, in the present embodiment, line electrode 33-2 is shown as open (i.e., not in use).

Conventionally, gas discharge tubes are designed to handle a multitude of transient impulses without failure. However, it has been found that GDTs often experience an operational failure mode, or fail state, if exposed to a relatively sustained surge of high-current energy.

It should be noted that a GDT typically provides no readily discernable notification upon reaching its failure mode. Additionally, GDTs most commonly fail in an open condition. As a result, a surge protection circuit with a failed GDT often provides no indication that its surge-handling capabilities have been compromised and that a load connected to the circuit is no longer protected from any potentially harmful, transient energy present on the signal path, which is highly undesirable.

As a solution to this problem, gas discharge tubes are often equipped with a fail-short mechanism that shunts its line electrodes to ground upon reaching its failure mode. For instance, GDT 31 is shown equipped with a fail-short mechanism 41. As seen in FIGS. 2(a) and 2(b), fail-short mechanism 41 comprises a spring-like arm 43 that is conductively coupled, at one end, to ground electrode 33-3. A shorting bar 45 is integrally formed onto the distal end of spring arm 43 and includes a L-shaped ends 47-1 and 47-2 which are positioned in direct alignment with line electrodes 33-1 and 33-2, respectively. A solder pellet 49 is applied between shorting bar 45 and ceramic body 37 of GDT 31 to space ends 47-1 and 47-2 adequately away from electrodes 33-1 and 33-2, respectively.

When a sustained, high-current, electrical surge applied to transmission line causes GDT 31 to fire, ceramic body 37 increases in temperature. Once ceramic body 37 reaches a threshold temperature that is typically associated with a failure mode condition (e.g., 215° C.-217° C.), solder pellet 49 is designed to melt or otherwise break down. Due to the spring-like construction of arm 45, the breakdown of pellet 49 resiliently draws ends 47-1 and 47-2 of shorting bar 45 into direct contact with terminals electrodes 33-1 and 33-2, respectively. As a result, electrodes 33-1 and 33-2 are permanently shunted to ground terminal 33-3, thereby creating a fail-short condition in GDT 31 in which all electromagnetic energy present on transmission line 13 is directly shunted to ground 21.

As a result, a GDT equipped with a fail-short mechanism adequately protects any loads connected to its output port, even upon reaching its failure mode. However, at the same time, a GDT in its fail-short state would significantly compromise the overall transmission characteristics of the electrical device. Furthermore, because conventional GDTs typically provide no indication that a fail-short condition has been reached, the transmission characteristics of the electrical device often remain compromised for a considerable period of time before it is determined that the electric device is not operating properly and that the surge protection circuit requires immediate repair or replacement.

### SUMMARY OF THE INVENTION

It is an object of the present invention to provide a new and improved surge protection circuit for transmitting electromagnetic signals of a desired frequency band along a transmission line.

It is another object of the present invention to provide a surge protection circuit as described above that includes a gas discharge tube, or other similar surge protection device, for suppressing any potentially harmful, transient, high-voltage electromagnetic energy present on the transmission line.

It is yet another object of the present invention to provide a surge protection circuit as described above which is designed to monitor the operational state of the gas discharge tube.

It is still another object of the present invention to provide a surge protection circuit as described above which is designed to adequately treat any potentially harmful, transient, high-voltage electromagnetic energy present on the transmission line when the gas discharge tube is in its fail state.

It is yet still another object of the present invention to provide a surge protection circuit as described above which has a limited number of parts, is inexpensive to manufacture, and efficiently transmits electromagnetic signals with minimum loss and limited distortion.

Accordingly, as one feature of the present invention, there is provided a surge protection circuit for transmitting electromagnetic signals of an operational frequency band, the surge protection circuit comprising (a) a transmission line connecting an input terminal to an output terminal, (b) a surge suppression device for treating any high-voltage, transient electromagnetic energy received by the transmission line, the surge suppression device having an operational state that transitions between an active operational state and an inactive operational state, the surge suppression device connecting the transmission line to a ground terminal, the surge suppression device being connected to the transmission line between the input terminal and the output terminal, and (c) a subcircuit for monitoring the operational state of the surge suppression device.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings, wherein like reference numerals represent like parts:

FIG. 1 is a schematic representation of a surge suppression circuit which is known in the art;

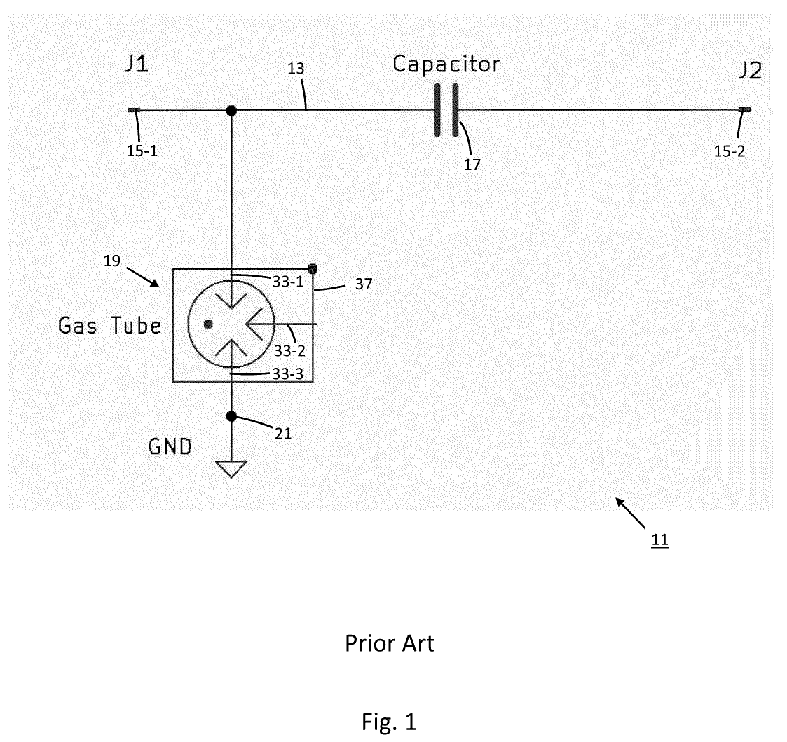

FIGS. 2(a) and 2(b) are front and left end views, respectively, of a prior art gas discharge that is commonly utilized in surge suppression circuits of the type as shown in FIG. 1;

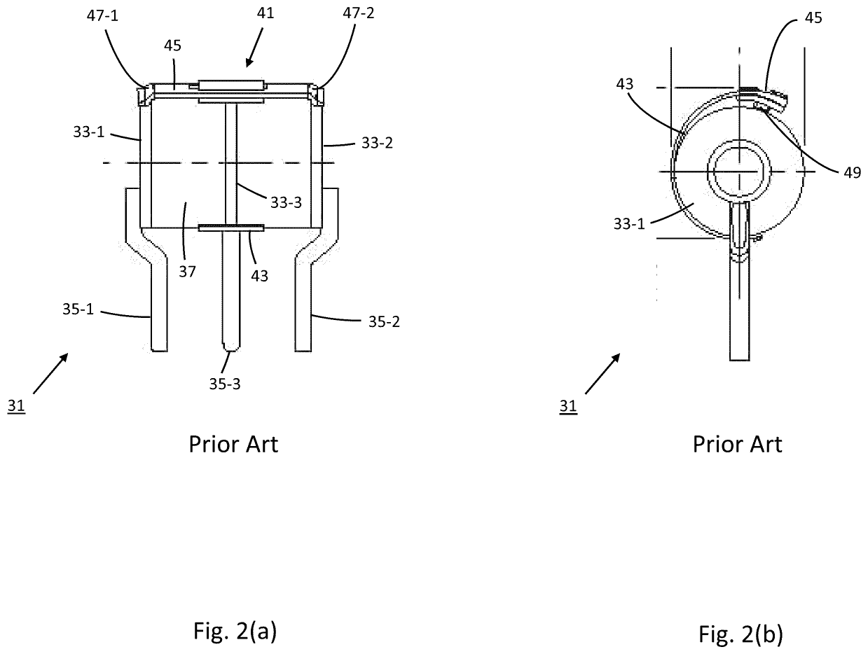

FIG. 3 is a schematic representation of a surge suppression circuit constructed according to the teachings of the present invention, the surge suppression circuit being shown when the gas discharge tube is in its active state; and

FIG. 4 is schematic representation of the surge suppression circuit of FIG. 3, the surge suppression circuit being shown when the gas discharge tube is in its inactive state.

### DETAILED DESCRIPTION OF THE INVENTION

### Surge Protection Circuit 111

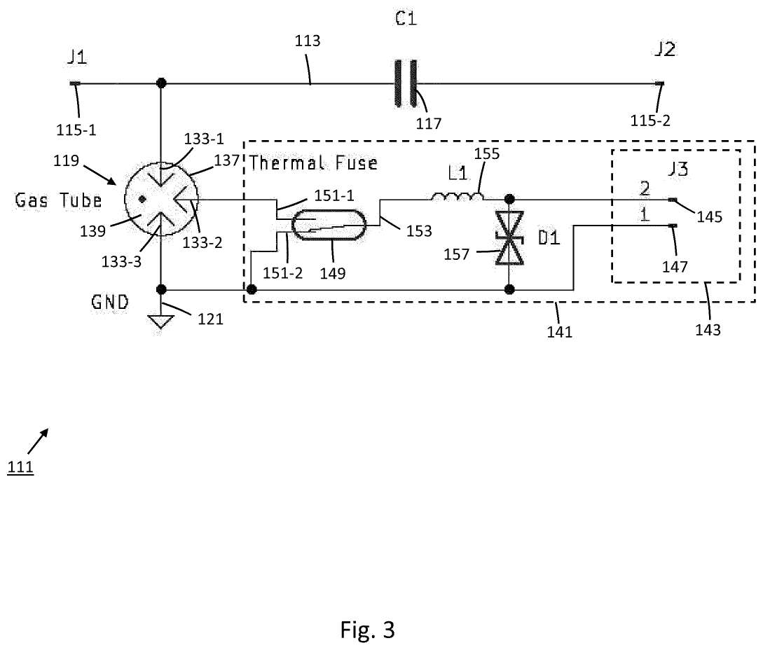

Referring now to FIG. 3, there is shown a surge protection circuit constructed according to the teachings of the present invention, the circuit being defined generally by reference numeral 111. In use, surge protection circuit 111 is designed to transmit radio frequency (RF) signals of a designated frequency range along a transmission line. As will be described further below, surge protection circuit 111 is provided with a surge protection device for suppressing unwanted transient voltages (e.g., of the type caused by lightning strikes or electro-static discharge) present on the transmission line, thereby protecting any voltage-sensitive circuit components or equipment connected thereto. As a principal feature of the present invention, surge protection circuit 111 additionally includes means for monitoring the operational state of the surge protection device in order to ensure that the most optimal signal transmission and surge protection capabilities of circuit 111 are maintained.

As can be seen, surge protection circuit 111 comprises a transmission line, or signal path, 113 that extends in electrical communication between an input, or exposed, terminal 115-1 and an output, or treated, terminal 115-2. Transmission line 113 provides a circuit path for passing radio frequency (RF) signals of a designated frequency range from input terminal 115-1 to output terminal 115-2.

Surge protection circuit 111 is designed with a pair of components to treat potentially harmful, high-voltage, transient electromagnetic energy present on transmission line 113. As such, any voltage-sensitive circuitry or equipment connected to output terminal 115-2 is adequately protected.

Specifically, surge protection circuit 111 includes a filter 117 for removing any electromagnetic signals that fall below the operational frequency band from transmission to output terminal 115-2. As a result, the electromagnetic energy blocked by filter 117 includes, in part, any high-voltage, transient electromagnetic impulses that fall beneath the operational frequency band. In the present embodiment, filter 117 is represented as a capacitor that is located in series on transmission 113 between input terminal 115-1 and output terminal 115-2. Preferably, filter 117 has a voltage rating that is suitable to handle a transient impulse of any realistic voltage.

Additionally, surge protection circuit 111 includes a surge protection device 119 that is designed to, inter alia, treat any high-voltage, transient, electromagnetic pulses that fall within the operational frequency band. Surge protection device 119 connects transmission line 113 to a ground terminal, or ground, 121, with surge protection device 119 being preferably connected to transmission line 113 at a location between input terminal 115-1 and filter 117.

In normal operation, circuit 111 is designed to pass RF signals of a designated frequency band between a signal source and a load. If any potentially harmful, transient, high-current RF energy within the operational frequency band is introduced to transmission line 113 (e.g., as a result of a lightning strike or electro-static discharge), protection device 119 is designed to activate so as to suppresses the potentially harmful energy. As a result, any low-voltage circuitry connected to output terminal 115-2 is protected from the unwanted, high-voltage energy.

Surge protection device 119 is represented herein as a single, three-electrode, gas discharge tube (GDT). It should be noted that a gas discharge tube is particularly well suited for use as the primary suppressor of high-voltage transient energy received by transmission line 113 due to its very high current-handling capability and relatively low capacitance. Additionally, for reasons to become apparent below, a GDT is well suited for use as surge protection device 119 in circuit 111 since a GDT exhibits a thermal response in proportion to the suppressed electrical impulse on transmission line 113. However, it is to be understood that alternative types of voltage limiting devices that (i) exhibit a thermal response to a treated electrical surge, and (ii) do not significantly hinder the signal transmission characteristics of circuit 111 could be used in place of a GDT without departing from the spirit of the present invention.

GDT 119 is represented herein as a conventional three-terminal GDT (e.g., similar in construction to prior art GDT 31) that includes a pair of disc-shaped, line electrodes, or terminals, 133-1 and 133-2 that are disposed on opposite sides of a central, disc-shaped, ground electrode, or terminal, 133-3 in a coaxial relationship relative thereto. Line electrodes 133-1 and 133-2 are maintained in a spaced apart, electrically insulated relationship relative to ground electrode 133-3 by a hollow, cylindrical, ceramic body, or casing, 137. Together, electrodes 133 and casing 137 define an enclosed interior cavity 139 that is filled with a controlled gas, which ordinarily acts as an insulator between electrodes 133.

However, the introduction of high-voltage transient energy onto signal path 113 creates a voltage potential between electrodes 133 which, upon reaching a certain level, causes the internal gas to ionize. Ultimately, this ionization creates a low-resistance current path throughout interior cavity 139 of GDT 119 that effectively discharges the high-current energy without increasing the arc voltage across terminals 133, thereby protecting output terminal 115-2 from the high-voltage energy.

In the present embodiment, primary line electrode 133-1 is shown connected to transmission line 113 between input terminal 115-1 and filter 117. Additionally, ground electrode 133-2 is shown connected to ground 121. As will be explained further below, secondary line electrode 133-2 is utilized to monitor the operational state of GDT 119.

When in its normal, or active, operational state, GDT 119 is designed to handle a multitude of electrical impulses without failure. However, exposure to a relatively sustained surge of high-current energy can cause GDT 119 to enter into a fail, or inactive, operational state. When in its fail state, GDT 119 is no longer capable of providing surge suppression capabilities to transmission line 113, which is highly undesirable.

Accordingly, as a primary feature of the present invention, surge protection circuit 111 is designed with a GDT monitoring subcircuit 141 for monitoring the operational state of gas discharge tube 119. In this manner, upon detecting failure of GDT 119, subcircuit 141 can provide a suitable notification that circuit 111 needs to be replaced or repaired, as needed, to restore its surge protection capabilities.

It should be noted that the incorporation of GDT monitoring subcircuit 141 in surge protection circuit 111 may reduce its RF transmission range (e.g., from approximately 1 GHz to approximately 500 MHz-650 MHz). However, the ability to monitor the active status of the surge suppression capabilities of circuit 111 provides such a considerable advantage over conventional surge protection circuits that it greatly offsets any reduction in its signal transmission performance.

### GDT Monitoring Subcircuit 141

GDT monitoring subcircuit 141 connects the terminal end of secondary line electrode 133-2 to ground 121. As will be explained further below, surge monitoring subcircuit includes a monitoring port 143 which provides the capability to detect if GDT 119 has entered into an inactive, or fail, operational state.

Monitoring port 143 includes (i) a monitoring, or indicator, terminal 145, and (ii) a ground terminal 147 connected to ground 121. Monitoring port 143 is preferably implemented as a terminal block, or header, that is adapted to releasably receive the mating connector for a GDT monitoring device (not shown), as will be explained further below.

GDT monitoring subcircuit 141 comprises a thermal fuse, or switch, 149 that is preferably mounted directly onto casing 137 of GDT 119. As can be seen, thermal switch 149 comprises (i) a first input lead 151-1 connected to secondary line electrode 133-2 of GDT 119, (ii) a second input lead 151-2 connected to ground 121, and (iii) an output lead 153 in connection with monitoring terminal 145 of port 143.

GDT monitoring subcircuit 141 additionally comprises an inductor 151 connected in series on output lead 153 between thermal fuse 149 and monitoring terminal 145. As can be appreciated, inductor 151 is incorporated into subcircuit 141 to provide RF isolation between gas discharge tube 119 and monitor port 143.

Lastly, GDT monitoring subcircuit 141 comprises a Zener diode 157 connected in parallel with monitoring port 143, with one end of Zener diode 157 being connected to output lead 153 between inductor 155 and monitoring terminal 145 and the other end of Zener diode 157 being connected to ground 121. As can be appreciated, Zener diode 157 represents any suitable semi-conductor clamping component that can be used to treat high-voltage electrical surges present on output lead 153 and thereby protect an electrical monitoring instrument coupled to port 143.

### Operation of Surge Protection Circuit 111

Surge protection circuit 111 is designed to pass RF signals of a designated frequency band along transmission line 113 from input terminal 115-1 to output terminal 115-2. As a feature of the present invention, surge protection circuit 111 is equipped with GDT 119 to treat any transient, high-voltage electromagnetic impulses in signal path 113 that may otherwise harm electrical components and circuitry connected to output terminal 115-2.

As previously referenced, GDT 119 is designed to handle a multitude of transient impulses without failure. However, GDT 119 may reach a fail operational state if exposed to a relatively sustained surge of high-current energy. With GDT 119 in its fail state, circuit 111 would inadequately protect a load connected to output terminal 115-2 from future transient electrical surges, which is highly undesirable.

Accordingly, surge protection circuit 111 is designed with a subcircuit 141 that allows for the operational state of GDT 119 to be monitored. More specifically, a monitoring device (not shown) capable of measuring resistance, such as a multimeter, is electrically coupled to monitoring port 143. The monitoring device preferably includes a processor that is uniquely programmed to monitor fluctuations in the measured resistance at terminal 145.

With GDT 119 in its active operational state, thermal fuse 149 is normally open, as shown in FIG. 3. As a result, monitoring terminal 145 is connected to ground 121. With monitoring terminal 145 connected as such, the measured resistance at monitoring terminal 145 will remain a steady, consistent value.

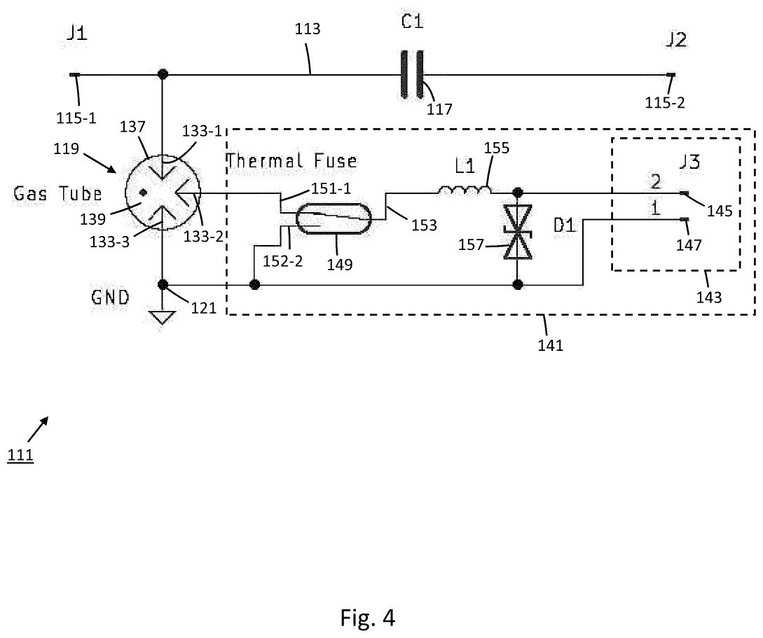

However, when a sustained, high-current, electrical surge applied to transmission line 113 causes GDT 119 to fire, ceramic body 137 increases in temperature. Once ceramic body 137 reaches a threshold temperature that is typically associated with a failure mode condition (e.g., 215° C.-217° C.), thermal fuse 149 is designed to switch into its closed condition, as shown in FIG. 4. With thermal fuse 149 closed, monitoring terminal 145 is switched into connection with secondary line electrode 133-2. As can be appreciated, this change in the switching state of fuse 149 causes the measured resistance at monitoring terminal 145 to vary from its otherwise consistent value. This variance in the measured resistance at monitoring terminal 145 can be readily detected by a monitoring device coupled to port 143. In turn, the monitoring device can provide a suitable notification that GDT 119 is in a fail operational state and that circuit 111 requires immediate replacement or repair.

The invention described in detail above is intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A surge protection circuit for transmitting electromagnetic signals of an operational frequency band, the surge protection circuit comprising:
(a) a transmission line connecting an input terminal to an output terminal;
(b) a surge suppression device for treating any high-voltage, transient electromagnetic energy received by the transmission line, the surge suppression device having an operational state that transitions between an active operational state and an inactive operational state, the surge suppression device connecting the transmission line to a ground terminal, the surge suppression device being connected to the transmission line between the input terminal and the output terminal; and
(c) a subcircuit for monitoring the operational state of the surge suppression device.

2. The surge protection circuit as claimed in claim 1 wherein the surge suppression device is only capable of treating high-voltage, transient electromagnetic energy present on the transmission line when in its active operational state.

3. The surge protection circuit as claimed in claim 2 wherein the surge suppression device exhibits a thermal response to treating high-voltage, transient electromagnetic energy present on the transmission line.

4. The surge protection circuit as claimed in claim 3 wherein the subcircuit monitors the operational state of the surge suppression device using the thermal response exhibited by the surge suppression device when treating high-voltage, transient electromagnetic energy present on the transmission line.

5. The surge protection circuit as claimed in claim 4 wherein the subcircuit comprises:
(a) a thermal fuse mounted onto the surge suppression device, the thermal fuse having an open switching state and a closed switching state, the thermal fuse being normally in its open switching state; and
(b) a monitoring port in connection with the thermal fuse.

6. The surge protection circuit as claimed in claim 5 wherein the surge suppression device is normally in its active operational state.

7. The surge protection circuit as claimed in claim 6 wherein the surge suppression device generates a thermal response of a threshold temperature upon transitioning from its active operational state to its inactive operational state.

8. The surge protection circuit as claimed in claim 7 wherein the thermal fuse switches from its open switching state to its closed switching state when the thermal response exhibited by the surge suppression device when treating high-voltage, transient electromagnetic energy present on the transmission line reaches the threshold temperature.

9. The surge protection circuit as claimed in claim 8 wherein the monitoring port provides a measurable resistance value.

10. The surge protection circuit as claimed in claim 9 wherein a variance in the measurable resistance value at the monitoring port indicates that the surge suppression device has transitioned to its inactive operational state.

11. The surge protection circuit as claimed in claim 10 wherein the surge suppression device is in the form of a three-terminal gas discharge tube.

12. The surge protection circuit as claimed in claim 11 wherein the gas discharge tube comprises:
(a) a first line electrode connected to the transmission line;
(b) a second line electrode connected to the monitoring subcircuit;
(c) a ground electrode connected to the ground terminal; and
(d) a casing for maintaining the first line electrode, second line electrode, and ground electrode in an electrically insulated relationship relative to one another.

13. The surge protection circuit as claimed in claim 12 wherein the first line electrode, second line electrode, ground electrode and casing together define an enclosed interior cavity that is filed with a controlled gas.

14. The surge protection circuit as claimed in claim 13 wherein the thermal fuse is mounted onto the casing of the gas discharge tube.

15. The surge protection circuit as claimed in claim 14 wherein the thermal fuse comprises:
(a) a first input lead connected to the second line electrode of the gas discharge tube;
(b) a second input lead connected to the ground terminal; and
(c) an output lead connected to the monitoring port.

16. The surge protection circuit as claimed in claim 15 wherein the monitoring subcircuit comprises an inductor connected in series on the output lead between the thermal fuse and the monitoring port.

17. The surge protection circuit as claimed in claim 16 wherein the monitoring subcircuit comprises a Zener diode connected in parallel with the monitoring port, the Zener diode having a first end connected to the output lead between the inductor and the monitoring terminal and a second end connected to the ground terminal.
